(19) United States
(12) Patent Application Publication
(10) Pub. No.: US 2024/0246823 A1
(43) Pub. Date: Jul. 25, 2024

(54) CARBON SEQUESTRATION IN ANOXIC ZONES

(71) Applicant: Carboniferous Inc., Oakland, CA (US)

(72) Inventors: Robert Alden Morris, Oakland, CA (US); David Taylor Jackson, Needham, MA (US); Andrew Jordan Felker, Livermore, CA (US)

(73) Assignee: Carboniferous Inc., Oakland, CA (US)

(21) Appl. No.: 18/559,867

(22) PCT Filed: Nov. 10, 2022
(86) PCT No.: PCT/US2022/049532

§ 371 Date: Nov. 9, 2023

Related U.S. Application Data
(60) Provisional application No. 63/264,410, filed on Nov. 22, 2021.

(51) Int. Cl. C01B 32/00; B09B 3/65

(52) U.S. Cl. CPC C01B 32/00; B09B 3/65

(57) ABSTRACT

A process and article for carbon sequestration including inducing a negative buoyancy in a carbon source with a non-buoyant material and submerging the carbon source into an aqueous anoxic environment. The negative buoyancy may be induced by bundling or baling the carbon source or by mixing it with a slurry.

### CROSS-REFERENCE TO RELATED APPLICATION

This application is a continuation of PCT/US2022/049532, which claims the benefit of priority of U.S. provisional application No. 63/264,410, filed Nov. 22, 2021, the contents of which are herein incorporated by reference.

### BACKGROUND OF THE INVENTION

The present invention relates to carbon sequestration and, more particularly, to an article and process for carbon sequestration encased in an anoxic zone.

Rising carbon dioxide (CO2) levels in Earth's atmosphere present potentially disastrous consequences including global warming and ocean acidification. Reducing the production of CO2 from industrial processes and slowing the rate of CO2 accumulation in the atmosphere may not be enough to adequately prevent said consequences. In addition, ongoing industrial processes worldwide make it challenging to decarbonize rapidly, to any appreciable extent. Thus, CO2 must be removed from the atmosphere by way of sequestration for a significant period of time, such as a millennia or ideally for geological time scales.

With net annual emissions of 40-50 gigatons (Gt) of CO2 annually, current atmospheric CO2 levels almost double pre-industrial levels circa 1870. The agricultural industry alone, which comprises animal by-products and soil emissions, accounts for net emissions of approximately 5-6 Gt/year of CO2 equivalent, including approximately 3.3 Gt/year CO2 equivalent in the form of methane emissions and approximately 2.8 Gt/year CO2 equivalent in the form of nitrous oxide emissions. This equates to approximately 10% of the annual total of CO2 emissions. A significant portion of that methane is released into the atmosphere from cow manure or flatulence. Methane's global warming potential is estimated to be 28-34 times greater than that of CO2.

The same increases in industrial activity affecting CO2 levels in the atmosphere also contribute to a rise in heavy metals in Earth's soil such as cadmium, chromium, copper, mercury, lead, arsenic, nickel, and zinc. These heavy metals are non-degradable and hazardous to life.

For a carbon sequestration technology to effectively combat rising CO2 levels, the scale of carbon sequestration must be greater than 10 Gt/year for more than 20 years. For the same technology to be sustainable and affordable, the cost of sequestration must be less than approximately $100/ton of carbon. In addition, the environmental side effects must be minimal, and the technology must inspire minimal opposition or aversion from the public at large. When these conditions are met, the carbon sequestration technology will be sustainable from both a financial and an environmental standpoint.

Accordingly, a carbon removal technique operating at a high Gt/year scale is needed. Some strategies have been proposed to turn agriculture from an emitter into a sequester. Each proposed strategy has so far been either financially or environmentally infeasible.

One strategy referred to as soil sequestration, the burying of crop residue in a field to sequester its carbon content, is inefficient and temporary. Studies have shown that more than 90% of the sequestered carbon is released into the atmosphere within twenty years from its sequestration. Thus, long-term carbon sequestration by such means is impractical. Another strategy, alkaline absorption, suggests absorbing CO2 from the atmosphere, compressing that CO2, and then injecting the compressed CO2 into a deep saline aquifer for sequestration. A large-scale implementation of this strategy is only theoretical due to associated costs. Estimates for such a cost range from $600-$900 US Dollars per ton of carbon and present-day costs are $1,100 per ton. As over 750 gigatons of carbon dioxide needs to be removed to return the atmosphere to pre-industrial conditions, this method is financially infeasible.

Another form of carbon sequestration that uses biomass as a feedstock is called bio-oil injection, which consists of gathering biomass, grinding, performing pyrolysis, and injecting into an existing oil well. This method of sequestration can only be used near existing oil wells and is geographically constrained and has a reduced carbon efficiency because of the energy used during fast pyrolysis.

Enhanced weathering is another type of carbon sequestration strategy that can be performed on land or in the ocean. When performed on land, the process involves distributing small particles of crushed olivine rock over the surface of a field. This process can increase the amount of toxic metals in otherwise healthy land. Moreover, no strategy has addressed the issue of removing heavy metals from Earth's soil. When performed in the ocean, the ultimate amount of carbon sequestered is difficult to measure when compared to other carbon sequestration strategies.

Current proposals utilizing the ocean to sequestrate carbon biomass are CROPS and ocean iron fertilization. The CROPS method calls for sequestering terrestrial biomass at the bottom of the ocean, where it may be covered by ocean sediment. Critical problems with this procedure include damage to the ocean bottom and uncertainty of the biomatter actually being covered by sediment. This uncertainty increases as time increases given natural events which may shift and affect the ocean floor. A concern for damaging the ocean bottom led authors of the CROPS paper to later describe the method as “unsavory.” In a follow up work, they wrote “the authors acknowledge that the idea is generally disagreeable.” An alteration of CROPS includes burying the biomass in sediment at the ocean bottom. In addition to its high cost, this alternative is difficult to implement and can be highly disruptive to the environment.

An alternative proposed method referred to as ocean iron fertilization proposes seeding the ocean with excess iron, producing a plankton bloom near the surface of the ocean. In theory, the plankton will absorb carbon, then sequester that carbon by sinking to the bottom of the ocean. This proposal faces several key challenges including the likelihood of causing the desired plankton bloom. Only some parts of the ocean are iron deficient. Therefore, iron fertilization will not work in all areas. It is also difficult to assess where the plankton settle in the water column and if the plankton will reach the bottom of the ocean in mass. The plankton may be eaten up by zooplankton, instead of sinking to the ocean floor, as shown in the LAHOFEX experiment. There is also a risk of creating deoxygenated ‘dead zones’ in unwanted areas as a harmful by-product.

These methods fail because they risk severe damage to global oceans, are financially infeasible, cannot be audited to verify or measure the sequestered carbon, and are not consistent or reliable.

One challenge with burying biomass in the ocean is that organic plant matter is naturally buoyant, primarily due to capillaries and voids in stems. Molecules in the plants, which are sequestering the CO2 are not buoyant. For example, the density of salt water is ˜1.02 g/ml whereas the density of the molecules composing a plant is meaningfully higher ˜1.3-1.5 g/ml. In order to achieve permanent sequestration, there is a need for an article or method densify the material such that it sinks and remains at a bottom of the ocean.

Biomass, including bales of biological matter, may be lowered to depth (potentially several hundred meters) before substantial compressive force comes into effect. “Lowering” the biomass to this depth may require significant mechanical work, as the biomass is positively buoyant and must be “pulled” to a deeper depth before reaching the critical depth. Current methods utilizing a ballast or mechanical work to pull a biomass deeper into the ocean may involve a meaningful expenditure of energy and/or a one-time use ballast before the ballast is sunk and not readily used again.

Accordingly, a need exists for an improved method and an article for carbon sequestration that addresses such issues.

### SUMMARY OF THE INVENTION

In one aspect of the present invention, a carbon sequestration process comprises inducing a negative buoyancy in a carbon source with a non-buoyant material and submerging the carbon source into an aqueous anoxic environment. The negative buoyancy may be induced by bundling or baling the carbon source or by mixing it with a slurry.

In another aspect of the present invention, an article comprises a carbon source joined with a non-buoyant material wherein the carbon source is submerged into an aqueous anoxic environment.

These and other features, aspects and advantages of the present invention will become better understood with reference to the following drawings, description, and claims.

### BRIEF DESCRIPTION OF THE DRAWINGS

FIG. 1 depicts a carbon source according to an embodiment of the present invention;

FIG. 2 depicts a bundle thereof with a non-buoyant material according to an embodiment of the present invention;

FIG. 3 depicts transporting the bundle thereof by ship;

FIG. 4 depicts sequestering the bundle thereof in an aqueous anoxic environment;

FIG. 5 is a flow chart depicting method steps of a method according to an embodiment of the present invention;

FIG. 6 depicts a bundle thereof submerging in anoxic waters;

FIG. 7 depicts an enclosed tube surrounding a submerging bundle thereof according to an embodiment of the present invention;

FIG. 8 depicts a densified material forming a container by a hydraulic press according to an embodiment of the present invention;

FIG. 9 depicts the container thereof with a carbon source according to an embodiment of the present invention;

FIG. 10 depicts a sealed container formed by the densified material, enveloping the carbon source according to an embodiment of the present invention;

FIG. 11 shows a top plan view of a natural deep-sea basin;

FIG. 12 shows a perspective view thereof;

FIG. 13 shows a perspective view thereof with an engineered wall forming an anoxic basin;

FIG. 14 depicts a carbon source mixed with a non-buoyant material to form a slurry, poured into an anoxic basin;

FIG. 15 depicts a continuous pulley system to lower a carbon source into an anoxic basin according to an embodiment of the present invention with a heavy weight;

FIG. 16 depicts a continuous pulley system thereof with attached ballasts; and

FIG. 17 depicts the continuous pulley system thereof with a heavy chain.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims with reference to the drawings.

A general overview of the various features of the invention will be provided, with a detailed description following. Broadly, an embodiment of the present invention provides a method, process, and article of carbon sequestration in an anoxic environment. An anoxic environment is an area depleted of oxygen, such as a deep-sea ocean basin which has likely neither been in contact with an oxygen-rich atmosphere in centuries nor has likely not mixed with oxygen-rich surface waters in centuries.

An anoxic basin typically forms when a ‘bowl-like’ shape of an ocean bottom prevents ocean currents from mixing with a water in a basin. As organisms and bacteria naturally consume oxygen in the basin, the basin becomes anoxic. Oxygenated water is not refreshed via ocean circulation. With limited oxygen, or chemical gradients, the anoxic basin is a dead zone and hostile to life. While such basins exist across Earth's ocean floor, it is estimated that 99.8% of the ocean bottom is not anoxic. Said differently, approximately only 0.2% of Earth's ocean floor features an anoxic basin. The sequestration of a carbon source, such as biomatter, into these anoxic basins, may achieve sequestration on a geological time scale.

The sequestration of carbon or biomass residue in an anoxic basin analogizes the process which formed fossil fuels eons ago in the Carboniferous period, 290 to 360 million years ago. At that time, bacteria could not yet decompose lignin. So large trees grew on top of each other and came to rest in swamps of undecomposed trees. These trees, left undisturbed by bacteria for millennia, transformed into coal, forming approximately 90% of the coal presently on Earth.

The sequestration of carbon in anoxic basins parallels said coal forming process by taking advantage of two characteristics of these anoxic basins: a minimal mixing of waters in the basin with an oxygen-rich upper oceanic layer and the stability of terrestrially derived organic matter in a deep-sea environment due to a lack of oxygen, light, and temperature gradients. Such advantages minimize and remove biological and chemical interaction from the sequestered carbon, enabling long-term sequestration.

The anoxic basins feature a lack of circulation or interaction with the broader ocean ecosystem. Therefore, sequestered carbon would not interact with ocean life and consequently would not harm ocean life. Moreover, ocean currents will not displace the sequestered carbon from anoxic basins because there are no interacting currents. If there were, the basin would not be anoxic. The sequestration of carbon in anoxic basins resolves the primary issues of CROPS by targeting a sequestration site to these peculiar and lifeless environments, the 0.2% of the ocean bottom that is anoxic. Furthermore, most naturally occurring carbon in Earth's biosphere is already in deep sediments, giving rise to the presumption that there will be no adverse, unforeseen consequences.

The carbon source may be submerged in an aqueous anoxic environment such as a basin in the ocean. The type of carbon source is not particularly limited by the present invention and any carbon source that does not sufficiently or substantially dissolve in the ocean may be used such as corn, sugarcane bagasse, corn stover, hay, haylage, or forestry by-products. To maximize the cost effectiveness, a cheap carbon dense material, with low water content, and low sulfur and nitrogen content may be used. An example of such a cheap carbon dense source would be a corn stover, sugarcane bagasse, straw, or other residue, commonly left in a field after harvest. The carbon source may also be undesirable for use as a fuel or fertilizer, making it an advantageous choice. Additionally, non-crop carbon sources may be used such as paper, wood, or food waste. Manure may be mixed with the carbon source. The manure serves as an additional carbon source, a method to prevent terrestrial methane emissions (methanogenesis) and may act as an adhesive to hold the carbon source together.

The carbon source may include or be intermixed with a plant matter contaminated with heavy metals, such as a hyperaccumulator of heavy metals. Plants classified as hyperaccumulators may gather nonessential elements, such as heavy metals, at a rate 100-fold greater than other plants. Mixing such contaminated plant matter with the carbon source may effectively sequester said heavy metals, removing them from usable soil.

A negative buoyancy may be induced in the carbon source. In some embodiments, the carbon source may be baled or bundled into a configuration suitable for transport or submersion into the ocean, such as hay bales. The carbon source may be bundled and joined with a non-buoyant material or anchor such as brick, sand, construction by-products, or other materials for the purpose of sinking the carbon source into the ocean.

The carbon source may be moved to a seaport either before or after baling, bundling, or stacking of loose material. Procurement of the carbon source close to water transportation may reduce transportation costs, thus increasing sustainability. When at a site of the aqueous anoxic environment, the carbon source is submerged or sunk at the site.

When the carbon source is in an anoxic environment such as the anoxic ocean basin, the lack of oxygen, light, and temperature gradient reduces a breakdown of the carbon source by bacteria or chemical interaction dramatically. The lack of circulation and mixing with above waters leaves the carbon source undisturbed in the anoxic environment for significant periods of time such as thousands of years. The carbon source may sink into a sediment at a bottom of the body of water. Immersion into the sediment will decrease any interaction of the carbon source with its environment, further sequestering the carbon source.

The carbon source may be doped with anoxia inducing agents such as salts, anti-microbial materials, or oxygen depleting microbes. The anoxia inducing agent may be added to the carbon source before or during the bundling process. The anoxia inducing agents contribute to the generation of a toxic and oxygen-free environment. The doping may generate minimal gas volumes, thus minimizing the potential for harmful gas production. The anoxia-inducing agent may be enhanced by a microbe that outcompetes carbon source-metabolizing microbes.

In some embodiments of the present invention, a negative buoyancy may be induced in the carbon source by mixing it with or in a slurry. A reverse-dredging process may deposit the slurry with the carbon source into the aqueous anoxic environment. The slurry may comprise the carbon source and a non-buoyant material such as sand, dirt, compost, rock, or debris. The slurry may further comprise water. The carbon source may be joined or intermixed with the non-buoyant material. Manure may be included in the slurry as well. The slurry may further comprise a binding agent to hold the slurry together and/or an anoxia inducing agent. In the reverse-dredging process, the slurry may be formed and inserted into an enclosed tube. The enclosed tube may guide the slurry through an oxic portion of the ocean and into the anoxic basin.

An anoxic basin may also be engineered and man-made. An engineered anoxic basin as well as a naturally occurring anoxic basin may be used for the sequestration of carbon sources. A pre-existing open pit mine or a fractured salt mine may be a site of an engineered anoxic basin. A new basin may also be dug or mined. The engineered anoxic basin may be formed by filling the site with water and removing or allowing nature to remove the oxygen. Anoxia may be induced by a low circulation of water. Warmer temperatures increase the induction of anoxia. A carbon source may then be deposited into the engineered anoxic basin. The basin may then be covered or sealed.

When lowering or submerging organic material into an anoxic basin, there is a risk of mixing oxic and anoxic water via eddy currents from downward moving bales or material. To contain these eddy currents, and minimize any additional oxygenation, an enclosed tube or pipe may be configured around the lowering bales to minimize the propagation of these vortices. The enclosed tube may guide the bundles into the anoxic basin. The enclosed tube may also prevent a mixing of anoxic waters with oxic waters.

Water pressure at an adequate depth may naturally compress biological material. Internal capillaries and voids of the biological material may be similarly compressed, further reducing buoyancy of the material. This compression becomes greater as depth increases. At a critical depth, compression from water pressure will cause organic material to switch from less dense than water (positively buoyant) to more dense than water (negatively buoyant). An aspect of the present invention comprises an approach to densifying biological matter without or in combination with a use of a press or machine.

In some embodiments, the carbon source may be or include a biodiesel such as a fuel derived from plants or animals capable of compression to a negative buoyancy. The biodiesel may be compressed or placed in a container capable of withstanding compression when compressed to a point of negative buoyancy.

In some embodiments of the present invention, a machine may resemble a self-sustaining reverse ski-lift. The machine may utilize natural forces or mechanical energy to achieve a continuous workflow of lowering a large amount of biomass past the critical depth. The machine may maximize the amount of biomass lowered past the critical depth or critical compression point while minimizing work required to do so. The machine of the present invention may lower or eliminate an amount of ballast used. The biomass may be in the form of a bale.

The machine may utilize a device such as a chain or conveyer that extends below the critical depth. The device may be flexible, rigid, or solid. Bales may attach to the device via an attachment mechanism. The attachment mechanism may be a chain or a hook. The weight of the device, weights attached to the device, the attachment device, a weighted contraption at a low point of the device, or a combination thereof may be heavy enough to counteract buoyant force of the biomass contained by or attached to the device. The device may also be attached to a weight or anchor sitting on a bottom of the sea floor. The device may start by pulling a first biomass or bale downwards requiring an expenditure of mechanical energy as the initial bale(s) are positively buoyant. They exert an upwards force so they must be ‘pulled’ down. Once the bales pass the critical depth, compression by water pressure changes the bales from positively to negatively buoyant. The bales now exert a downwards force. At said point, the bales may be immediately released (dropping to the ocean floor) or remain connected to the machine, supplying additional downward force for the machine, thereby pulling a next bale. The device lowering the bales may revolve or circle forming a constant flow of bales towards an anoxic basin. Embodiments of the present invention are not particularly limited to bales. In a nonlimiting example, loose materials contained in a tube, a basket, a bucket, or other container suitable to carry or push loose biomass below the critical depth where it may sink or continue sinking without energy recapture from the sinking material.

By keeping negatively buoyant bales connected to the revolving chain or device, the negatively buoyant bales may now provide downward force to pull more bales below the critical compression depth. As such, once the downwards force of negatively buoyant bales exceeds both the upwards force of the positively buoyant bales and the mechanical frictions and resistances of the machine, the process may run continually without input power or a reduced input power. By this mechanism, with only a small application of initial power, a user may continually compress and lower bales into an anoxic basin. Advantageously, the machine may be self-sustaining, may eliminate or reduce a need for alternative compression or densification, save or generate energy, reduce capital costs, reduce operational costs, and reduce or eliminate the ballast required to make the biomass negatively buoyant.

In some embodiments of the present invention, the carbon source may be enveloped in a material such as a densified material, a preserving material, a liner, or another man-made local barrier. The enveloping material may generate a local anoxic environment around the carbon source.

A densification process may form the densified material. The densification process may comprise pressing an ingredient, such as biochar, with a press, such as a hydraulic press, or applying a pressure to the ingredient. The pressure applied and the composition of the materials pressed may vary, altering structural properties of the densified material to decrease its permeability. The densified material may envelop the carbon source, forming the anoxic environment. The densified material may then be wrapped in a preserving material such as plastic, mud, or concrete and may have a steel or other metallic shell or liner which seals the wrapping. The wrapping material and liner preserve the anoxic environment. The enveloped material may be stored in an undisturbed location such as underwater or above ground in an anoxic environment. The densified material, the preserving material, and the liner further sequester the carbon source, limiting contact with bacteria or chemicals which may decompose the carbon source.

Alternatively, the carbon source may be enveloped in a preserving material and submerged into an anoxic basin. A pressure from a depth of the ocean may densify the material.

The enveloped carbon source may also be used as a structural member in construction. Said structural members may help form an engineered anoxic environment. The structural members may be positioned around a natural environment amenable to forming an anoxic environment such as a deep ocean salt seep or the surroundings of a naturally forming anoxic basin. The positioning of the structural members may form an engineered wall, limiting the availability of light, oxygen, and a temperature gradient and any mixing of deep-sea waters. This may produce an engineered anoxic environment or an expanded anoxic environment. The engineered anoxic environment may then be filled with unenveloped carbon sources.

To ensure the sequestration process has worked, and will likely work for many centuries, the sequestration of carbon sources in anoxic basins may be monitored. The carbon source may be measured before submersion into the anoxic basin. The carbon source may also be monitored after submersion into the anoxic basin by measuring a mass, size, or volume of the carbon source with radar, sonar, or gamma radiation. Additionally, the water in the anoxic basin may be sampled for chemical and genomic signatures of unwanted metabolism of the sequestered material. Such sampling may be performed by measuring a chemical property of a water column at a geographical location of the anoxic basin and/or changes to a microbiome at the anoxic basin. These chemical or volumetric measurements may be compared with other measurements, mathematical formulas, or predictions to determine the adequacy or efficiency of the sequestration. These measurements may be used to create a monitoring, reporting, and verification framework. Said framework may be required by a regulator such as the Environmental Protection Agency, EPA, and/or its global counterparts.

Potential sites for the sequestration of carbon sources may be anoxic basins close to the United States near coordinates 27ºN, 91ºW, which host ideal conditions for the sequestration of carbon sources. Other anoxic basins adequate for the sequestration of carbon exist around the world including the Black Sea, the Caspian Sea, the Red Sea, the Mediterranean Sea, and the Caribbean Sea.

A proximity of waterways to a potential, ubiquitous carbon source may increase the economic feasibility of transporting those crops via waterway, making agriculture a very viable carbon source. Multiple carbon sources are viable candidates, and each may present pros and cons, including availability, ease of shipping, cost, and longevity. For example, soybean may be a carbon source as soybean production in the United States frequently neighbors waterways.

In some embodiments, a carbon sequestration process comprises forming a densified material by applying a pressure, enveloping a carbon source in the densified material, wrapping the densified material in a preserving material, and sealing the densified material with a local barrier. The densified material may be formed with a hydraulic press.

In some embodiments, a carbon sequestration process comprises wrapping a carbon source in a preserving material, submerging the carbon source into an aqueous anoxic environment, and forming a densified material with pressure exerted by a depth of an ocean to the carbon source.

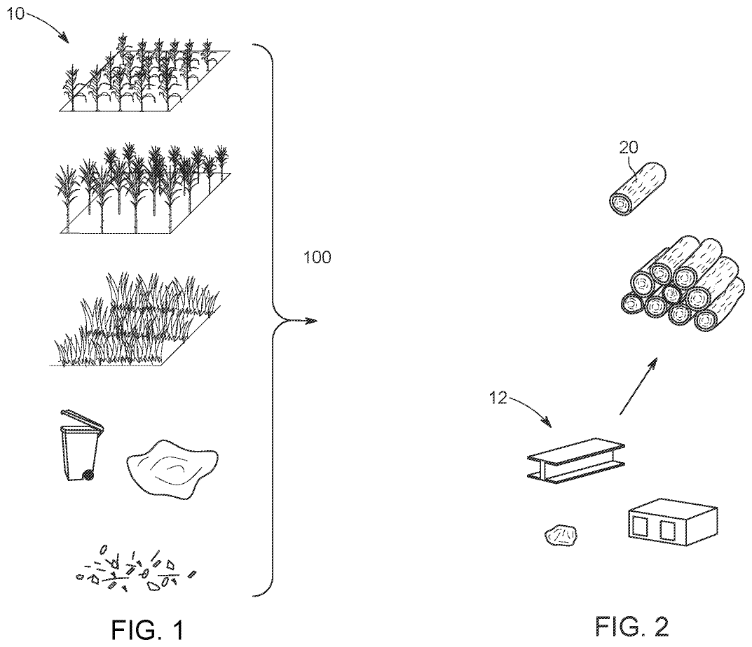

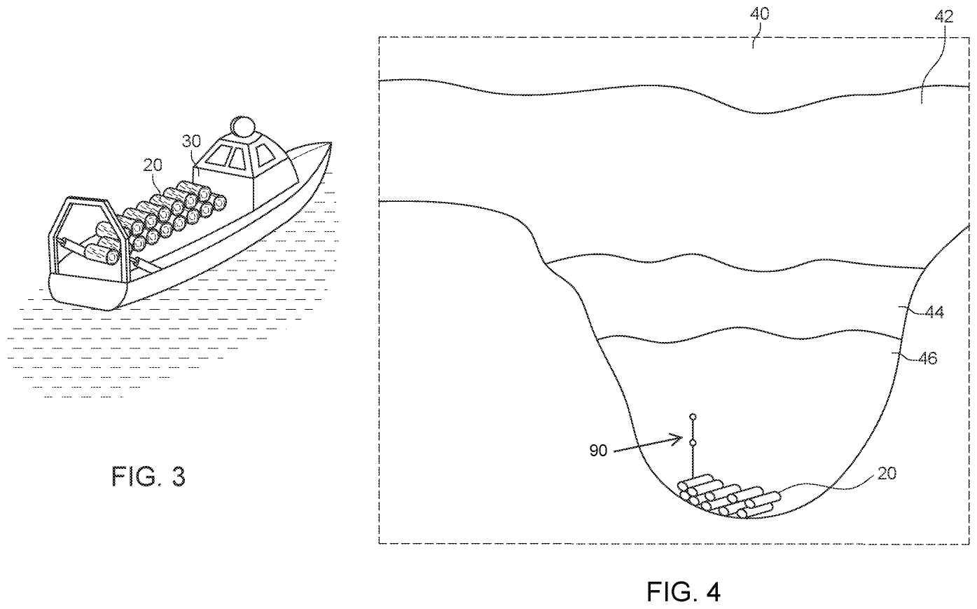

Referring now to the Figures, FIG. 1 and FIG. 2 depicts a carbon source 10 and a non-buoyant material 12 forming a bundle 20. The carbon source 10 may be corn, cane, grass/hay, compost stock, or wood. The non-buoyant material 12 may be metal, rock, or concrete. The bundle 20 is a combination of the carbon source 10 and the non-buoyant material 12, forming a bale such as a hay bale. FIG. 3 shows the bundles 20 being transported via ship 30.

FIG. 4 depicts an ocean environment where the bundles 20 are submerged. Above the ocean environment is air 40. An uppermost layer 42 of an ocean is in contact with the air 40. This uppermost layer 42 is the home to a majority of aquatic life such as fish, kelp, and flora. The uppermost layer 42 also contains oxygen-rich currents. A transition zone 44 lays below the uppermost layer 42. An anoxic zone 46 rests at a bottom of the ocean environment, below the transition zone 44. The bundles 20 lay submerged in the anoxic zone 46. A monitoring device 90 is positioned in the anoxic zone 46, measuring or sampling the anoxic zone 46 and/or the bundles or a mass thereof 20. The monitoring may be performed at periodic intervals and measure or sample chemical, biological, and/or genomic signatures indicating or indicative of a change in the anoxic zone 46 such as a loss of anoxic features.

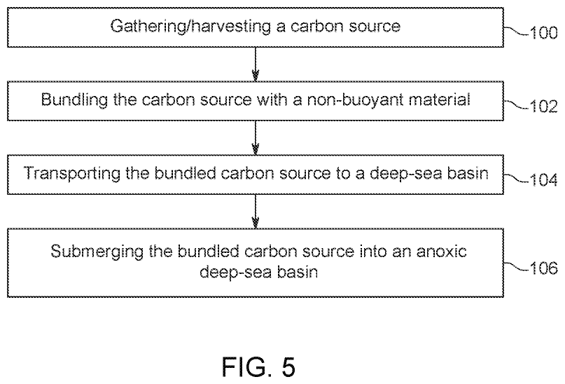

FIG. 5 is a flow chart depicting method steps according to an embodiment of the present invention. The carbon source may first be gathered or harvested 100. The carbon source may then be bundled with a non-buoyant material 102. The bundle is transported to an anoxic environment such as a deep-sea basin 104. The bundle is then submerged into the anoxic environment 106.

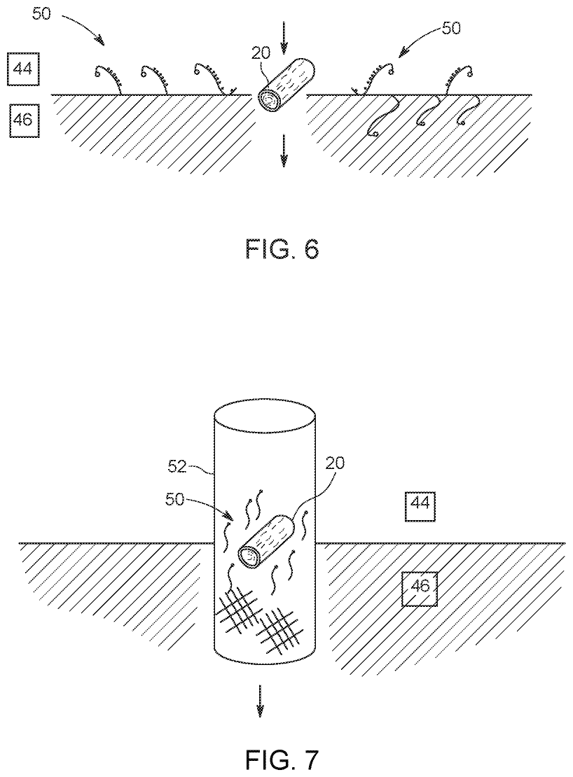

FIG. 6 depicts a bundle 20 being submerged and crossing from the transition zone 44 to the anoxic zone 46. As the bundle 20 submerges, it produces eddy currents 50. These currents may mix oxic and anoxic waters. FIG. 7 shows an embodiment of an enclosed tube 52 which guides submersion of the bundle 20. The enclosed tube 52 limits a spread of the eddy currents 50 and prevents mixing of the oxic and anoxic waters.

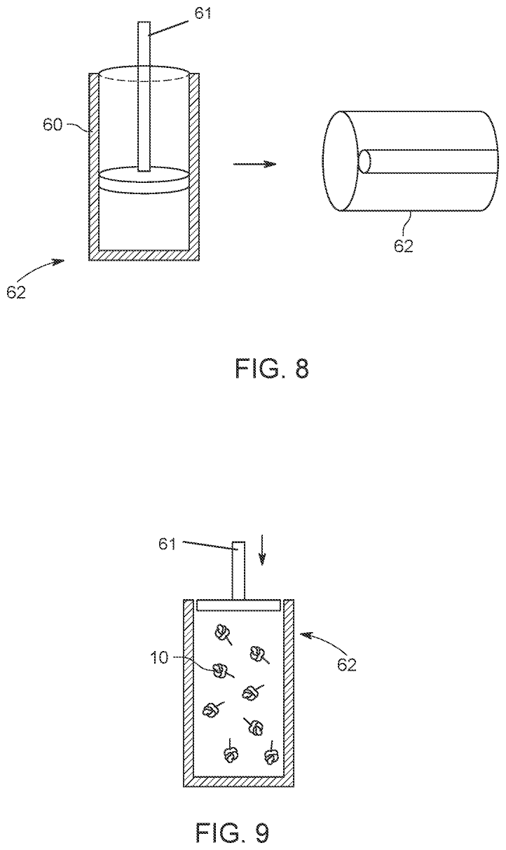

FIG. 8 shows a densified material 60 formed by a hydraulic press 61 according to an embodiment of the present invention. The densified material 60 may be a form of carbon. The densified material 60 is shaped into a container 62. The container 62 and densified material 60 may be formed by any suitable machine or combination of machines capable of densifying a material and forming the material into a suitable shape capable of enclosing a carbon source. The hydraulic press 61 is given by way of example only.

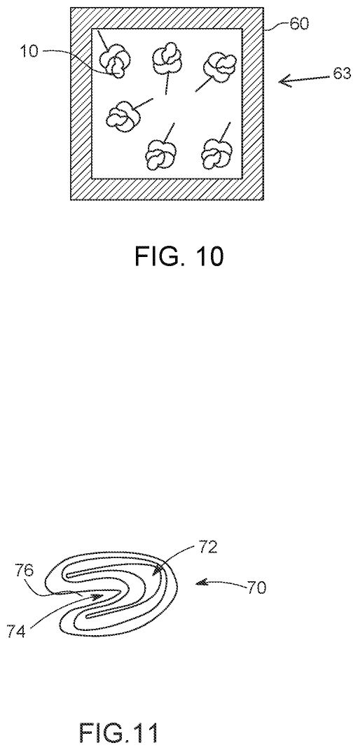

As shown in FIG. 9, the carbon source 10 is placed into the container 62. The carbon source 10 may then be pressed or compacted. The container 62 is then sealed. FIG. 10 shows a sealed container 63 enclosing the carbon source 10. The sealed container 63 may be non-buoyant, enabling it to sink when submerged into the ocean. The sealed container 63 may also further sequester the carbon source 10.

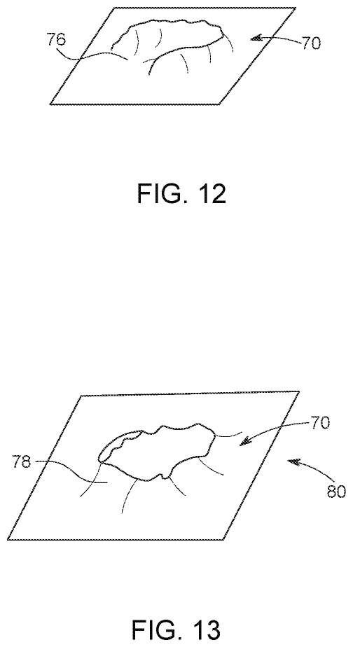

FIGS. 11 and 12 show a natural deep basin 70. The basin has a high ridge 72 and a low base 74. A gap 76 in the high ridge 72 exposes the low base 74 to waters from outside of the basin 70, preventing the waters in the low base 74 from becoming anoxic.

FIG. 13 shows the basin 70 with an engineered wall 78 closing the gap 76. The engineered wall 78 limits any mixing of waters inside of the basin 70 with outside waters, forming an engineered anoxic basin 80.

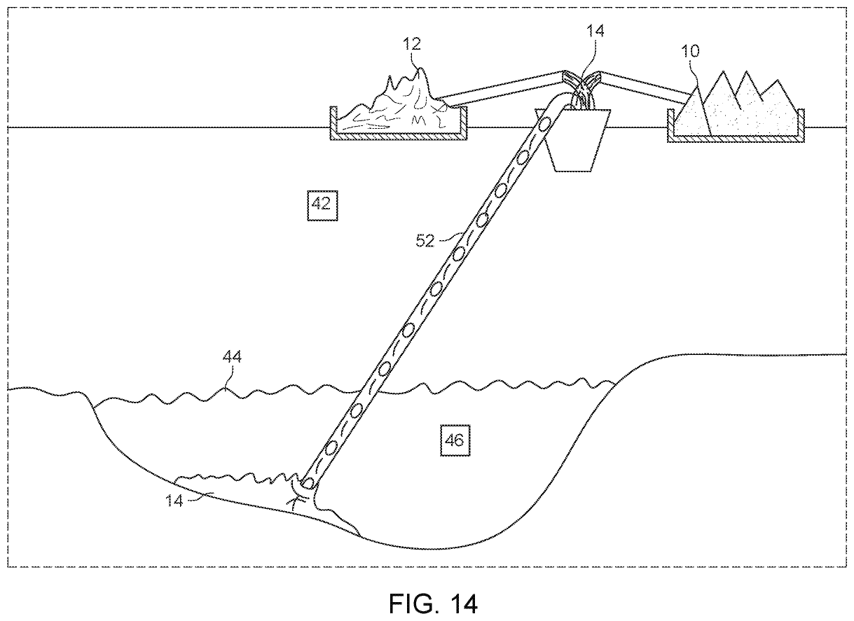

FIG. 14 details a system and method for depositing a carbon source 10 in an anoxic zone 46 according to an embodiment of the present invention. The carbon source 10 is mixed with a non-buoyant material 12 to form a slurry 14. The slurry travels down an enclosed tube 52 through the uppermost layer 42 of the ocean and through the transition zone 44 into the anoxic zone 46. Once in the anoxic zone 46, the slurry 14 may rest undisturbed.

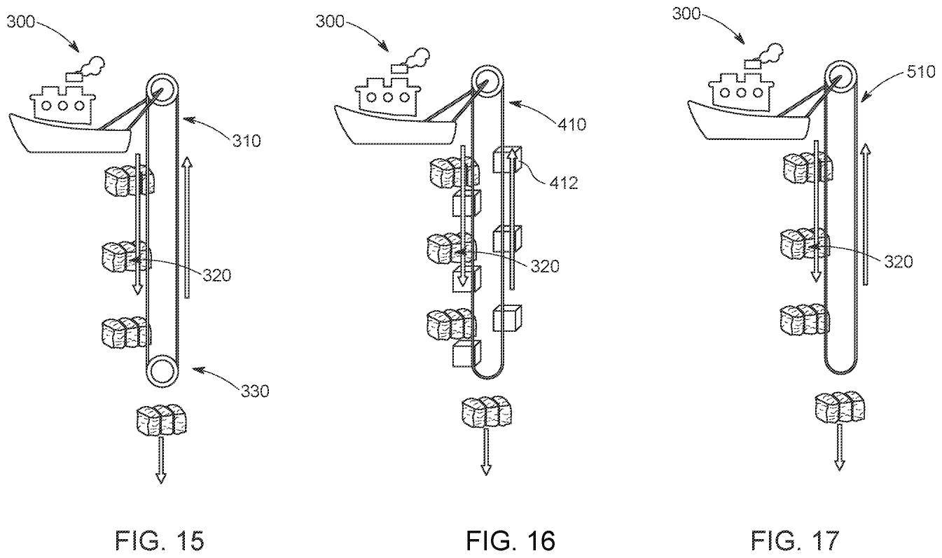

FIG. 15 details an alternate system and method for lowering bales 320 of a carbon biomass into an anoxic zone according to an embodiment of the present invention. A ship 300 utilizes a rotating chain 310 to lower the bales 320. The bales 320 may be attached to the rotating chain 310 and lowered until the bales 320 reach a predetermined depth. At the predetermined depth, the bales 320 may be released from the rotating chain 310 to sink into an aqueous environment. A weight 330 assists in maintaining a position of the rotating chain 310 relative to a water column in the ocean, such as by anchoring it, ensuring the bales 320 sink to a predetermined location such as the anoxic environment.

FIG. 16 details an alternate system and method for lowering bales 320. The ship 300 utilizes a rotating chain with ballasts 410. At a predetermined depth, the bales 320 may be released from the rotating chain with ballasts 410 to sink. The ballasts 412 remain affixed to the rotating chain with ballasts 410. The ballasts 412 assist in maintaining a position of the rotating chain 310 relative to a water column in the ocean, such as by anchoring it, ensuring the bales 320 sink to a predetermined location such as the anoxic environment.

FIG. 17 details another alternative system and method for lowering bales 320. The bales are affixed to a rotating heavy chain 510. At the predetermined depth, the bales 320 may be released from the rotating chain 310 to sink. A weight of the rotating heavy chain 510 assists in maintaining a position of the rotating chain 310 relative to a water column in the ocean, such as by anchoring it, ensuring the bales 320 sink to a predetermined location such as the anoxic environment.

It should be understood, of course, that the foregoing relates to exemplary embodiments of the invention and that modifications may be made without departing from the spirit and scope of the invention as set forth in the following claims.

What is claimed is:

1. A carbon sequestration process comprising:
inducing a negative buoyancy in a carbon source; and
submerging the carbon source into an aqueous anoxic environment.

2. The process of claim 1, wherein the carbon source is a solid carbon source.

3. The process of claim 2, wherein the negative buoyancy is induced in the solid carbon source by bundling the carbon source with a non-buoyant material.

4. The process of claim 2, wherein the negative buoyancy is induced in the solid carbon source by mixing the solid carbon source with a non-buoyant material in a slurry.

5. The process of claim 2, wherein the solid carbon source is intermixed with manure.

6. The process of claim 2, wherein the solid carbon source is intermixed with plant matter contaminated with heavy metals.

7. The process of claim 2, wherein the aqueous anoxic environment is an engineered anoxic basin.

8. The process of claim 2, further comprising monitoring the solid carbon source in the aqueous anoxic environment by measuring a mass of the solid carbon source.

9. The process of claim 8, wherein the solid carbon source is measured with radar to determine the mass of the solid carbon source.

10. The process of claim 8, wherein the solid carbon source is measured with sonar to determine the mass of the solid carbon source.

11. The process of claim 8, wherein the solid carbon source is measured with gamma radiation to determine the mass of the solid carbon source.

12. The process of claim 2, further comprising monitoring the solid carbon source in the aqueous anoxic environment by measuring a chemical property of a water column at the aqueous anoxic environment.

13. The process of claim 2, further comprising monitoring the solid carbon source in the aqueous anoxic environment by measuring microbiological activity at the aqueous anoxic environment.

14. The process of claim 2, further comprising doping the solid carbon source with an anoxia inducing agent.

15. The process of claim 14, wherein the anoxia inducing agent is a salt.

16. The process of claim 14, wherein the anoxia inducing agent is an anti-microbial material.

17. The process of claim 14, wherein the anoxia inducing agent is an oxygen depleting microbe.

18. The process of claim 14, wherein the anoxia inducing agent is enhanced by a microbe that outcompetes solid carbon source-metabolizing microbes.

19. The process of claim 2, wherein the solid carbon source is guided into the aqueous anoxic environment by an enclosed tube.

20. The process of claim 2, wherein the solid carbon source is lowered into the aqueous anoxic environment by a continuous pulley system.

21. The process of claim 20, wherein the continuous pulley system further comprises a rotating chain operative to lowering and releasing the solid carbon source into the aqueous anoxic environment.

22. The process of claim 21, wherein the rotating chain is anchored by a heavy weight.

23. The process of claim 21, wherein ballasts are affixed to the rotating chain and rotate with the rotating chain wherein the ballasts assist in maintaining a position of the rotating chain relative to a water column above an anoxic aqueous environment.

24. The process of claim 21, wherein the rotating chain is heavy enough to maintain a position of the rotating chain relative to a water column above an anoxic aqueous environment.

25. The process of claim 1, wherein the carbon source is a biodiesel capable of being compressed to a negative buoyancy and placed in a container capable of withstanding compression when compressed to a point of negative buoyancy.

26. An article for sequestering carbon comprising:
a solid carbon source joined with a non-buoyant material wherein the solid carbon source is submerged into an aqueous anoxic environment.

27. The article of claim 26 wherein the solid carbon source is bundled with the non-buoyant material.

28. The article of claim 26 wherein the solid carbon source is mixed in a slurry with the non-buoyant material.

29. The article of claim 26, wherein the solid carbon source is intermixed with manure.

30. The article of claim 26, wherein the solid carbon source is intermixed with plant matter contaminated with heavy metals.

31. The article of claim 26, wherein the aqueous anoxic environment is an engineered anoxic basin.

32. The article of claim 26, further comprising an anoxia inducing agent.

33. The article of claim 32, wherein the anoxia inducing agent is a salt.

34. The article of claim 32, wherein the anoxia inducing agent is an anti-microbial material.

35. The article of claim 32, wherein the anoxia inducing agent is an oxygen depleting microbe.

36. The article of claim 32, wherein the anoxia inducing agent is enhanced by a microbe that outcompetes solid carbon source-metabolizing microbes.

37. The process of claim 1, wherein inducing negative buoyancy further comprises increasing a depth of the carbon source in an aqueous environment to a threshold at which the density of the carbon source changes from an amount less than to an amount greater than that of surrounding water.

38. The process of claim 1, wherein inducing negative buoyancy further comprises compression of the carbon source in a press.

39. The process of claim 38, wherein the press is hydraulic.
